(19) United States
(12) Patent Application Publication
(10) Pub. No.: US 2020/0372814 A1
(43) Pub. Date: Nov. 26, 2020

(54) ON-BOARD COMMAND UNIT FOR A DRONE SYSTEM, DRONE AND DRONE SYSTEM INCLUDING THE ON-BOARD COMMAND UNIT

(71) Applicant: AIRBUS DEFENCE AND SPACE SAS, TOULOUSE CEDEX 4 (FR)

(72) Inventors: Frédéric BOS, ARNOUVILLE LÉS MANTES (FR); Thierry BERTOLACCI, ORGEVAL (FR)

(21) Appl. No.: 16/636,171

(22) PCT Filed: Jul. 26, 2018
(86) PCT No.: PCT/EP2018/070350

§ 371 Date: Feb. 3, 2020

(30) Foreign Application Priority Data
Aug. 1, 2017 (FR) 1757389

(51) Int. Cl. G08G 5/00; H04B 7/185

(52) U.S. Cl. CPC G08G 5/0039; H04B 7/18506

(57) ABSTRACT

An on-board command unit for an unmanned aircraft, according to which the on-board command unit is programmed specifically for a mission and configured to be connected to a flight control system of the unmanned aircraft, the flight control system including an autopilot module; the on-board command unit includes an environment sensor; the on-board command unit includes a unit for processing and memorising data coming from the environment sensor and mission parameters, the command unit being adapted to modify at least one parameter of the flight control system or a mission parameter on the basis of mission data and data coming from the environment sensor.

### TECHNICAL FIELD

The present invention relates to the field of unmanned aircraft, also designated by the term “drones” and notably drones capable of hovering, such as rotary wing aircraft. More specifically, the invention relates to command devices for drones and drone systems, applied to specific missions.

### PRIOR ART

Commercially available drones may be applied to different missions. Drone command systems include a flight control system enabling the pilot to command the aircraft from a ground station. The drone system, including the ground station and the drone, thus includes a datalink. These drones are generally intended for flight in a dedicated and relatively clear space.

Small sized drones are today widely commercially available and are generally equipped with a geographic localisation system, such as an on-board GPS, and a camera. The operator commanding the drone receives for example via the datalink geographic positioning information and data representative of images taken by the camera. Small sized drones may thus be commanded easily by the operator, as long as the drone remains within his field of view. This type of unmanned aircraft notably aims to offer, at low cost, a simplified command system. However, the command of the drone proves to be more arduous in the case where the drone advances outside of the field of view of the operator.

Command systems for more complex drone systems may include the management of infrared sensors, telemetric sensors or even the command of actuators. This type of drone system requires however a particularly high development cost. Moreover, such drones generally remain intended for missions including a take-off, a flight and a landing carried out in dedicated and relatively clear spaces. The flight notably outside of the field of view of the operator is based for example on the geographic positioning of the drone correlated, in the ground station, with a detailed mapping, allowing the operator to control the drone. However, this type of drone system proves to be insufficient in places where natural catastrophes, such as floods or earthquakes, occur modifying the geographic environment. Certain ground stations may also require the coordinated action of several operators in order to manage, for example, the control of the piloting and observation systems.

There is thus a need to provide a drone system enabling the execution of complex missions while facilitating the action of the operator and requiring a reasonable development cost.

### SUMMARY OF THE INVENTION

The present invention aims to overcome the drawbacks of the prior art by proposing an on-board command unit intended to simplify the implementation of drone systems for various missions, while enabling a reasonable development cost.

This objective is attained thanks to an on-board command unit for a flying platform including a flight control system controlling at least one propulsion unit of the flying platform, the flight control system including an autopilot module for managing flight commands, said on-board command unit being characterised in that:
the on-board command unit includes a data processing and memorisation unit and is configured to be connected to the flight control system and to generate flight command sequences addressed to the autopilot module;
the on-board command unit is configured for the management of at least one environment sensor generating data representative of an environment of the flying platform;
the on-board command unit memorises data for executing a determined mission and carries out a processing of data representative of the environment in such a way as to adapt data for executing the mission according to data coming from said environment sensor and to generate at least one new flight command with respect to the flight commands corresponding to data for executing said initially programmed determined mission.

Advantageously, the command unit according to the invention makes it possible to improve the autonomy of the drone and its adaptability to carry out missions for which the flying platform was not necessarily initially designed. Moreover, the command unit enables complex missions to be carried out, notably in an unknown or only partially known environment.

Generally speaking, the on-board command unit according to the invention makes it possible to modify the flight plan initially programmed in the unmanned aircraft. This modification of the flight plan may take place in an autonomous manner, without need for an operator on the ground. Indeed, the on-board command unit uses data coming from the environment sensor and interprets them with regards to mission data including the flight plan initially assigned to the unmanned aircraft. If an element capable, for example, of preventing the progress of the mission is detected, the command unit triggers in an autonomous manner safety functions. Such an element may be, for example, an unexpected obstacle or an unmapped modification of the terrain close to the landing point. The decision taken by the command unit may consist for example in a modification of the flight plan of the aircraft, so as to avoid the obstacle, or in a search for a new landing point. The command unit may also decide to place the aircraft in still flight before triggering other actions, such as for example a return to the take-off point.

The autonomous modification of the flight plan may also respond to a need of the mission assigned to the unmanned aircraft. It may be for example a mission to inspect an object of which the shape is not known. In such a situation, the on-board command unit according to the invention can modify the flight parameters of the unmanned aircraft so as to maintain a constant distance between the aircraft and the surface of the object to inspect, while scanning a surface of interest.

Advantageously, the on-board command unit is adapted to process data coming from the environment sensor and, thanks notably to the communication link with the autopilot module of the drone, the command unit can modify the flight commands of the aircraft for example to improve the mission safety. The programmed mission includes for example the flight plan and other instructions relating to one or more environment sensors, to one or more actuators or to other on-board instruments or devices. This ability makes possible for example to safeguard the mission even in the case of the datalink loss with the ground station. This ability also makes possible to increase the reliability of decisions taken on the basis of data supplied by an on-board sensor in the event where the operator is not able to evaluate the situation with sufficient accuracy from the ground station. Advantageously, the present invention facilitates the design of multi-mission unmanned aircraft, each mission being able to be successively programmed. Thanks to the command unit, the unmanned aircraft may be adapted rapidly to carry out different types of mission, independently of the flying platform.

Advantageously, the on-board command unit according to the invention may be adapted to a commercial available drone. To do so, it is just necessary, for example, integrate into the on-board command unit according to the invention the software driver, of the autopilot module of the commercially available drone. The on-board command unit may also include other communication ports and other drivers for controlling or receiving data from other instruments of the drone such as its camera, its IMU or its GPS. It is thus possible to recover easily a flying platform derived from a commercially available drone, notably by connecting up to its autopilot module. The on-board command unit will then be able to interact with the flight control system of the flying platform by transmitting instructions to the autopilot module.

Advantageously, the on-board command unit manages the sequencing of the flight and can modify the initial flight command sequences intended to be transmitted to the autopilot module, on the basis of data generated by its environment sensor(s). It could also be possible to foresee, without going beyond the scope of the invention, an environment sensor forming part of the flying platform and generating the data received and used by the command unit to modify the flight plan by transmitting, in return, sequences of modified commands to the autopilot.

Thanks to the on-board command unit according to the invention, the safety of the mission, such as the probability of successively completing the mission, are considerably improved.

A commercial available drone may be recovered and used in an easy manner to construct a new drone system making it possible to increase the autonomy of the drone through enhanced adaptation and decision making capacities. It involves for example for the drone to be able to continue the mission even in the case of a faulty datalink with the ground station. The drone may for example finely adapt its flight commands according to captured data generated in situ and inaccessible to the operator from the ground station. For the development of a particular mission, it thereby becomes possible to focus on the development of the command unit managing for example one or more environment sensors.

Further advantageously, the on-board command unit may include several functional modules such as for example, a proximity detection module, a module for detecting a landing zone or a follow a surface module. These software or electronic modules of the command unit may be used separately or in combination.

Advantageously, for example from a commercially available drone designed exclusively for observation, it could be possible to develop a new drone for transporting a load in a safe and secure manner. Such a load is for example intended to be dropped in a place not specifically provided for a landing. It may be a load intended to be left on the spot or intended to be recovered next by the drone to be transported to a different place.

The on-board command unit according to the invention may also include one or more of the characteristics below, considered individually or according to all technically possible combinations thereof:
The environment sensor forms part of the command unit and is of a type distinct from other instruments integrated in the flying platform;
The data processing and memorisation unit includes a data collecting module laid out in such a way as to carry out memory writing of dated data representative of the environment, merging with dated positioning data of the flying platform and correcting of dated data representative of the environment according to the positioning data;
The on-board command unit includes a module for formatting commands for the autopilot module and for retransmitting these commands to the autopilot, the command formatting module being able to be updated according to the flying platform and its flight control module;
The on-board command unit includes a communication module for communicating with a ground station carrying out a transmission of surveillance data generated by the command unit;
The on-board command unit includes an obstacle detection and avoidance module, said environment sensor being in the form of at least one detector of distance with respect to objects in the environment of the platform and oriented in the direction of a programmed displacement, the obstacle detection and avoidance module triggering, in the event of distance detected below a determined threshold, one or more of the following actions:
   Stopping in position,
   Avoidance of the obstacle,
   Return to a safe position,
   Search for a first new trajectory by linear or rotational displacement;
The on-board command unit includes a mapping module memorising data representative of obstacles merged with at least positioning data of the flying platform, these data being representative of a mapping of detected obstacles;
The on-board command unit is configured in such a way that the search for a new trajectory is carried out according to data representative of the mapping of detected obstacles;
The on-board command unit includes a landing module carrying out a detection of obstacles vertically below the flying platform in order to determine a set of points constituting a landing place having an area above a determined threshold and a flatness below a determined threshold;
The command unit is configured to determine said set of points constituting the landing place by successive iterations during the preparation for the descent of the flying platform;
The on-board command unit includes at least one environment sensor of thermal detector, infrared radiation detector or detector of wireless communication terminals type, the command unit triggering, in the event of a parameter detected above a determined threshold, one or more of the following actions:
   stopping for an in-depth analysis of the environment for a determined duration,
   slowing down of the speed for an in-depth analysis of the environment for a determined duration or until said detected parameter returns below the detection threshold,
   search for a second new trajectory for amplifying the detected parameter,

the detected parameter being able to be in the form of a thermal signature of determined intensity, a thermal image of determined extent, a digital radiofrequency signal of determined intensity.

Another object of the invention relates to a drone including at least one flying platform equipped with a flight control system controlling at least one propulsion unit of the flying platform, the flight control system comprising an autopilot module for managing flight commands, the drone further including an on-board command unit according to the invention.

According to another particularity, the drone includes a device for transporting a load intended to be dropped in a determined spot.

The drone according to the invention may also include one or more of the characteristics below, considered individually or according to all technically possible combinations thereof:
The drone includes a rotary wing flying platform comprising at least one mechanical structure for supporting a propulsion means supplied by an energy supply module;
The drone includes a flight control system comprising an autopilot module controlling the propulsion means.

Advantageously, the drone according to the invention may be developed for complex missions at a reasonable cost. Indeed, the development of the intelligence integrated in such a drone specifically for a mission then corresponds to the development of an additional high level software layer integrated in the command unit.

Another object of the invention relates to a drone system comprising a ground station in communication link with a drone according to the invention.

### LIST OF FIGURES

Other characteristics and advantages of the invention will become clear from the description that is given thereof below, for indicative purposes and in no way limiting, with reference to the appended figures given by way of example, among which:

FIG. 1 shows a diagram of an example of drone including an on-board command unit according to the invention;

FIG. 2 shows an example of diagram of the on-board command unit illustrated in FIG. 1 and sub-modules included in the on-board command unit;

FIG. 3 shows an example of embodiment of a “Sense and Avoid” type function, realised by means of the command unit illustrated in FIG. 2;

FIG. 4 shows an example of embodiment of a “Safe Landing” type function, realised by means of the on-board command unit illustrated in FIG. 2;

FIG. 5 shows an example of embodiment of a “Follow a Surface” type function, realised by means of the command unit illustrated in FIG. 2;

FIGS. 5a and 5b each show an example of coverage of a zone of interest;

FIG. 6 shows a diagram of a drone according to the invention and notably the links between the on-board command unit according to the invention and the autopilot module of an unmanned aircraft;

FIG. 7 shows in detail the flight sequencing in the case of implementation of a “Safe Landing” type function;

FIG. 8 shows a diagram of the drone system according to the invention;

FIG. 9 illustrates an example of flight plan of a programmed mission.

### DEFINITIONS

On-board command unit is taken to mean a device for processing data including for example a processor and a memory storing for example programme data, drivers or data representative of the environment of one or more sensors. The on-board command unit is for example capable of recording and processing data such as mission data and data coming from the environment sensor. The command unit includes modules realising functions, a module being able to be indiscriminately designated as module or sub-module in the case where it is called by another module.

Flying platform is taken to mean the assembly comprising notably the bearing structure, the thrusters and the flight control system capable of assuring the stability of the unmanned aircraft during flight and the execution of flight commands. The flight control system further includes an autopilot module enabling the execution of the flight commands received. These commands may concern, for example, the execution of a displacement, a rotation or a trajectory within the flight space provided by the mission.

Command unit programmed specifically for a mission is taken to mean a command unit which has memorised the data necessary for the implementation of a specific mission, comprising for example a landing spot or a trajectory. The programmed mission thereby includes an initially programmed flight plan. Various operations for controlling the environment or various other actions may be associated with the flight plan. These mission data may be memorised in the command unit prior to the start of the mission then adapted or clarified during the mission, as a function notably of the environment sensors.

Environment sensor is taken to mean a sensor generating data representative of its environment, such as for example, a sensor capable of measuring one or more distances between the drone and an object of the environment of the drone, a sensor for receiving sound signals or digital or analogic electromagnetic signals, a sensor for receiving light signals. A telemeter may for example measure distances along a line of points according to an angle of vision of the sensor. The angle of vision may be arranged for example under the drone or in front of the drone. The telemeter may also take measurements in different fields of view all around the drone. The telemeter is for example of the “range finder” type, such as a LIDAR.

### DETAILED DESCRIPTION

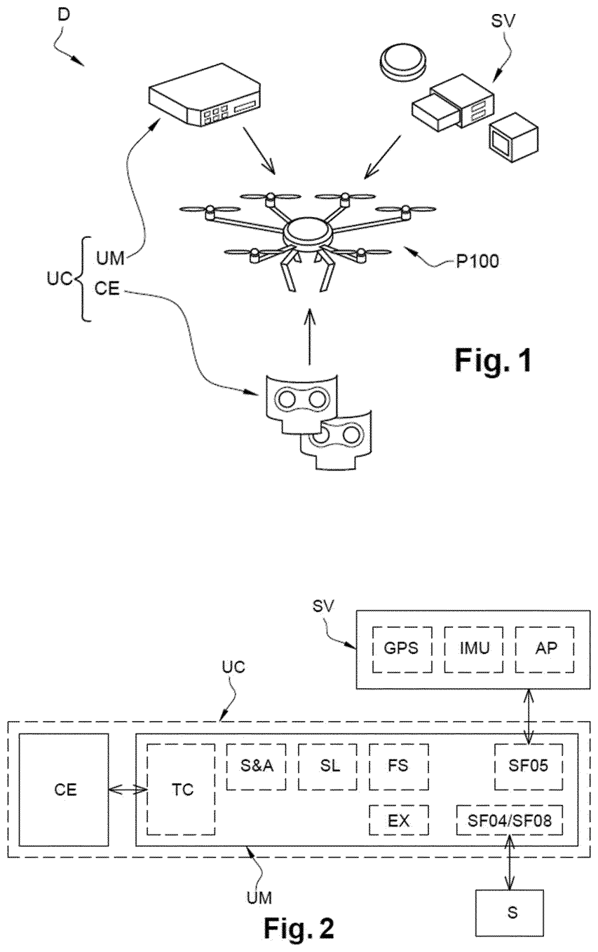

FIG. 1 shows, according to an exploded view, a drone D comprising a command unit UC according to the invention. The command unit UC includes for example a data processing and memorisation unit UM and one or more environment sensors CE.

The command unit UC is installed on a flying platform P100 comprising a flight control system SV. This control system notably includes an autopilot module AP. The flying platform P100 is for example of the rotary wing or fixed wing type. As represented in FIG. 1, the flying platform may be in the form of a hexacopter. This hexacopter is here derived from a commercial available drone of which the radiofrequency command module is for example conserved as a safety mean, even if a takeover of the commands in manual mode by the operator would only make it possible to carry out approximate maneuvers in comparison with command sequences being able to be carried out by the command unit according to the invention.

The data processing and memorisation unit UM is a calculation device notably comprising a processor and a memory linked by communication, addressing and control buses, as well as interfaces and communication lines linked with the flight control system SV of the flying platform and in particular with its autopilot. The means for establishing this datalink between the command unit and the flight control system may be for example in the form of an Ethernet link or a link via a USB port.

The autopilot module AP is capable of managing the flight commands of the flying platform. The autopilot module is for example capable of executing direct instructions such as moving from a first determined point of GPS coordinates to a second determined point of GPS coordinates or covering a given trajectory or instead maintaining the flying platform hovering above a given point. The autopilot may also be configured to execute instructions such as move forward, move backward or move to the right or move to the left, at a determined speed. The autopilot may also be configured to execute instructions such as upwards or downwards displacement, at a determined speed or instead rotation towards the right or left.

The flight control system SV may also include:
a radiofrequency transmitter/receiver, as described above for taking back commands directly by the operator for reasons of safety,
a GPS module notably enabling the execution of flight commands including trajectories between the determined geographic coordinates,
an inertial measurement unit (IMU),
a camera.

The transmitter-receiver enables for example direct command to be taken back by the operator for reasons of safety, but proves however to be absolutely not necessary for the implementation of the present invention, even if in practice, this radiofrequency transmitter-receiver will be conserved for reasons of additional safety or in the deactivated state.

The environment sensor is for example a telemeter type sensor, namely a sensor capable of measuring one or more distances between the drone D and one or more objects of its environment.

Examples of environment sensor of telemeter type are a LIDAR, a RADAR or any other sensor of “range finder” type.

Advantageously, the command unit UC is able to exploit data coming from the environment sensor to modify the command of the drone D by transmitting modified commands to the flight control system SV and in particular by giving modified flight commands to the autopilot module AP, without requiring the intervention of an operator acting from a ground station. In addition, the decisions taken by the command unit UC on the basis of environmental data supplied by the environment sensor(s) CE enable an adaptability to different types of mission. The command unit programmed specifically for a mission may for example executes the mission despite certain incomplete data, such as partially known map data.

Examples of missions are, for example, the exploration of an accident zone comprising the search for mobile terminals, with for example in the case of detection, an approach phase for establishing a communication link of sufficient quality, then a hovering phase of engagement of exchange of data with the detected mobile terminal(s). The exchange of data includes for example the transmission of information or questions and the awaiting of a response or an acknowledgement of receipt. The sensor for searching for and communicating with mobile terminals is for example used in collaboration with a telemeter detecting obstacles all around the drone in order to stop a search flight or an approach flight in the case of detection of an obstacle.

Another example of mission includes for example a landing in an unknown or poorly defined zone, as described in greater detail hereafter.

Another example of mission includes for example the drop of a load in an unknown or poorly defined geographic zone. Such a load may be a payload itself including one or more sensors and the communication means deployed on the spot. The load may also be in the form of a parcel to set down on the balcony of a building.

### Architecture of the Command Unit UC

FIG. 2 represents in a schematic manner an example of architecture of the on-board command unit UC according to the invention. The on-board command unit UC includes for example its environment sensor CE generating data representative of the environment of the drone stored in the memory of the data processing and memorisation unit UM. The collection of data is here managed by a data collecting module TC. The data processing and memorisation unit UM may also transmit parameterisation data to the environment sensor CE.

The data processing and memorisation unit UM, which includes for example a processor and a memory, enables the execution of programmes which can call on sub-programmes to realise functions and sub-functions for processing memorised data. A functional module is thus composed of one or more functions or sub-functions realised by one or more programmes or sub-programmes.

The calculator notably executes memorised programmes enabling the transmission of flight command sequences to the autopilot module AP. The module SF05, which carries out the function of driver of the autopilot, enables the transmission of command sequences that can be interpreted by the autopilot.

The different modules illustrated in a non-limiting manner in FIG. 2, include:
Modules SF04 and SF08 respectively for receiving and transmitting data via the communication link with the ground station S;
An obstacle avoidance module S&A for the realisation of an obstacle detection and avoidance function of obstacle detection and avoidance type, also designated by “Sense and Avoid”;
A safe landing module SL to carry out a safe landing;
A follow a surface module FS for the realisation of a function of positioning at a distance from a surface and for maintaining this distance during displacements of the drone;
The driver module SF05 for communicating with the flight control system SV of the platform and in particular with the autopilot module AP,
The module TC for collecting data and notably data coming from the environment sensor or instead data coming from the flight control system SV of the flying platform such as positioning data, supplied by the IMU and by the GPS,
The module EX for executing a memorised programme mission.

The modules shown schematically in FIG. 2 may be electronic modules physically connected in the command unit UM or may be programmes or sub-programmes installed in the memory of the command unit UC.

The modules SF04 and SF08 for communicating with a ground station make it possible to establish a datalink with the ground station. In fact, the accomplishment of a mission by a drone generally requires feedback of information by the drone, such as for example for exploration missions. The ground station S may also transmit parameters to modify the mission, notably according to data generated by the environment sensor. Advantageously, the link with the ground station may also be deactivated depending on the type of mission. The obstacle avoidance module S&A makes it possible to avoid known obstacles found on the initially programmed trajectory or arising unexpectedly on this trajectory such as moving objects. An example of implementation of the obstacle avoidance module will be described in detail hereafter.

Advantageously, a drone having complex functions of adaptability to a partially unknown environment or adaptability to a changing environment may easily be implemented.

The landing module SL notably enables the modification, the discovery, the evaluation or the selection of the landing place, by the command unit. An initially provided landing place is no longer for example accessible or the precise spot of the landing is not for example determined beforehand. An example of embodiment of the landing module will be described in greater detail hereafter.

The follow a surface module FS makes it possible for example to facilitate the inspection of a bridge pillar, without knowing precisely the arrangement of said pillar. The follow a surface module may also be used to inspect another object of interest or to carry out an approach phase. An example of embodiment of the follow a surface module will be described in greater detail hereafter.

Advantageously, these functions provide additional autonomy to the drone by allowing it to react to numerous situations. Thus a drone losing its communication link will for example be able to continue its mission or to stop it in a safe manner by a safe landing. The functions may be executed alone or in combination.

Complex missions may thereby be carried out by the drone, which has enhanced decisional autonomy. The complexity of missions may result for example from uncertainties on mapping data of the environment or on data relative to targets to detect or to inspect in which the drone is moving about.

### Obstacle Avoidance Module

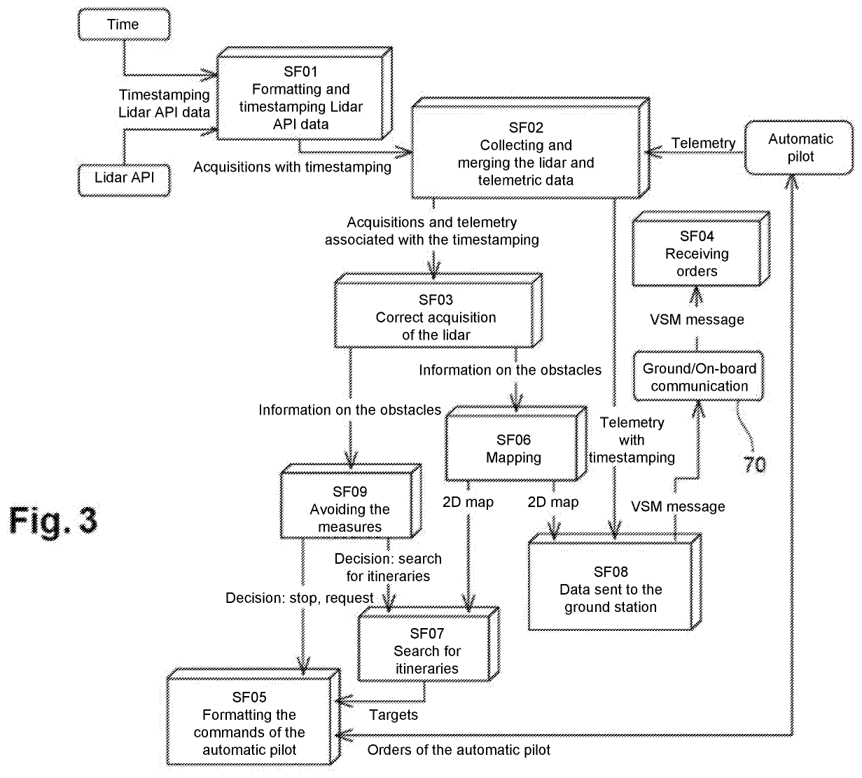

An example of detection and avoidance function is illustrated in FIG. 3. The environment sensor may for example be in the form of a LIDAR type sensor installed on the flying platform with its angle of vision forwards, the data generated by this sensor being used for the detection of obstacles found in front of the drone.

The detection and avoidance module S&A calls for example on several sub-modules. The detection and avoidance module S&A may thus associate, thanks to the data collecting module TC, a temporal information or “timestamp” memorised with each item of data acquired by the environment sensor CE. In a similar manner, the detection and avoidance module S&A associates, thanks to the data collecting module TC, a timestamp with each item of positioning data supplied by the autopilot module AP. The associated positioning data include for example data generated by the IMU and data generated by the GPS. The IMU notably generates pitching and rolling inclination data. The GPS notably generates longitude, latitude and altitude data.

The data collecting module TC includes for example a sub-module SF01 for memory writing dated data coming from the environment sensor and the flight control system.

Memorised dated data coming from the environment sensor are next merged, by a merger sub-module SF02, with dated positioning data coming from the flight control system. The positioning data notably include the inclination supplied by the inertial measurement unit IMU.

The metadata thereby obtained are next formatted thanks to the correction sub-module SF03, processing data representative of the environment according to the positioning information of the flying platform, so as to obtain more accurate information. The correction consists for example in taking into account the pitching and rolling inclinations of the drone with respect to horizontal, for example to eliminate detected zones corresponding in fact to horizontal flat ground lying under the drone.

The corrected information reveals for example the presence of a surface sufficiently close to the drone, in front of said drone, to be considered as an obstacle.

The detection threshold applied by the detection and avoidance module S&A is for example adjusted according to the forward speed of the drone.

Advantageously, the correction sub-module SF03 enables an interpretation of the collected data to evaluate whether the detected objects constitute relevant obstacles. Thus a detected object lying outside of the trajectory followed by the drone is not taken into account and does not trigger an avoidance action.

The detection and avoidance module S&A triggers, when an obstacle is detected, an avoidance action. The avoidance action includes for example a stoppage and a placing in hovering flight of the drone. The avoidance action may also include a modification of the flight command sequences transmitted to the autopilot resulting notably in a change in direction in order to bypass the obstacle.

The detection and avoidance module S&A is for example still active and periodically carries out, at a determined frequency, verifications of the corrected distances detected with respect to a detection threshold.

In the event of an obstacle detection, the detection and avoidance module S&A can also trigger the activation of a mapping sub-module SF06 classifying in a memory the corrected information having triggered the obstacle detection. All of said information on detected obstacles associated with the geographic positions of the drone may next be exploited, these data being representative of a mapping of the obstacles. By triggering bypassing actions the drone then constitutes a richer and richer mapping of obstacles where the obstacle zones are calculated by the drone itself. The detection and avoidance module S&A includes for example a sub-module SF09 for selecting an action among several determined avoidance actions.

The decision taken by the sub-module SF09 for selecting the avoidance action may result for example in:
An activation of a sub-module for recalculating the trajectory SF07 comprising as input parameter notably obstacle mapping data and transmission of a new sequence of flight commands;
An emergency stop and a stabilisation in stationary flight, for example for a drone of the rotary wing aircraft type;
A speed reduction;
A return to safe position;
The sending of a request for instructions to the ground station.

The determination of a new trajectory leads for example to the transmission of the new sequence of flight commands to the module driver SF05 in order to be transmitted to the autopilot module AP. The module driver SF05 then carries out a formatting of the commands addressed to the autopilot.

Advantageously, by simply changing the module driver SF05 it is easy to implement the obstacle detection and avoidance function, or another function, for another platform. Such another flying platform comes for example from a commercial available drone.

If the decision taken by the sub-module SF09 for selecting an avoidance action is to stop the flight and to place the platform in hovering flight, this instruction is for example transmitted to the autopilot module AP, via the driver module SF05.

If the decision taken by the sub-module SF09 for selecting an avoidance action is to ask for instructions from the ground station, the request for instructions is for example sent to the module SF08 for transmitting to the ground station.

On receipt of the message from the ground station, a reception sub-module SF04 carries out for example the reception and the addressing of the instructions in the on-board command unit.

The sub-module SF09 for selecting the avoidance action may also trigger several actions simultaneously or sequentially.

Here again, the command unit UC and its obstacle avoidance module S&A make it possible to provide enhanced autonomy to the drone.

The obstacle avoidance module S&A may also call the sub-module SF08 for the processing and sending of data, such as data coming from the environment sensor CE, to the ground station.

The on-board processing and memorisation unit includes a radio transmitter-receiver 70 in communication link with the ground station.

Landing Module

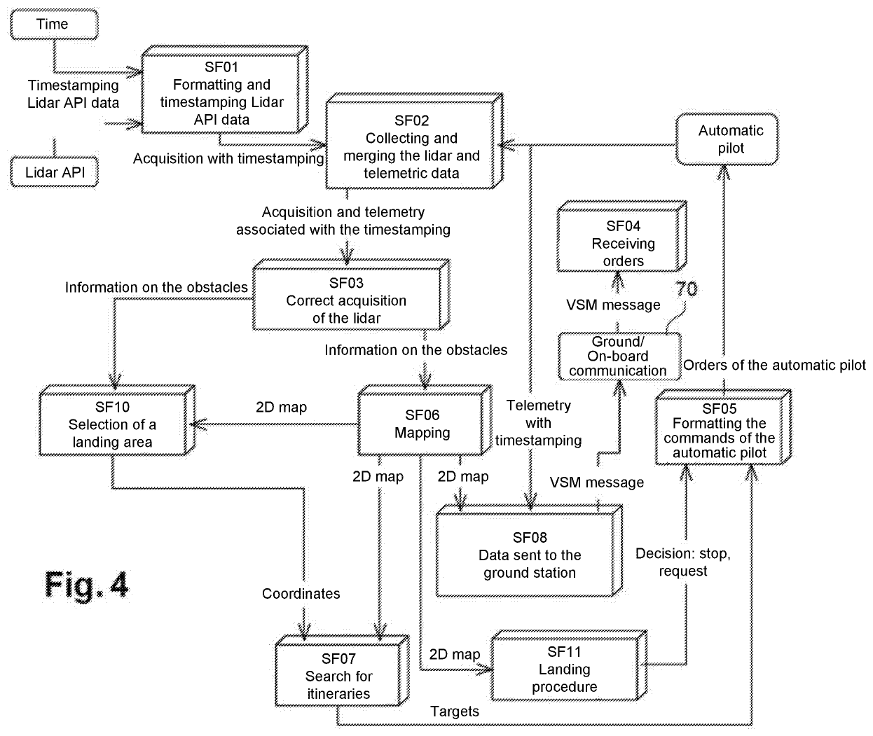

An example of embodiment of the landing module SL is illustrated in FIG. 4. Its purpose is for example to carry out, thanks to the environment sensor CE such as a LIDAR arranged with its field of view vertically under the drone, a scanning of the destination zone of the drone D and a search for an acceptable point for landing.

The landing module SL includes for example the data collecting module TC itself comprising, as described previously:
the sub-module SF01 for memory writing dated data coming from the environment sensor and the flight control system,
the sub-module SF02 for merging, with the dated positioning data coming for example from the flight control system,
the correction sub-module SF03, for processing data representative of the environment according to the positioning information of the flying platform.

The landing module SL may also include the mapping sub-module SF06. Data representative of a mapping of the obstacles may be used but also enriched by data representative of obstacles detected on the ground. Several types of obstacles are for example memorised during the activation of the mapping sub-module SF06 according to the type and the configuration of the environment sensor(s).

The map updated by the mapping sub-module SF06 is used by the sub-module SF10 for selecting a landing zone for the drone D. The selection of the landing point or the landing zone is made on the basis of criteria determined beforehand, such as the necessity of having a relatively gentle slope, a flat surface of determined extent of the zone or instead the absence of moving obstacles. The obstacle map reveals for example an extended fixed zone for which the sub-module SF10 for selecting a landing zone has calculated a slope and an inclination below the memorised acceptable thresholds. The sub-module SF10 for selecting a landing zone then memorises data representative of the geographic positioning of this validated landing zone.

The sub-module SF07 for calculating the trajectory may then be activated by the landing module SL to determine the trajectory up to the memorised validated landing zone.

The flight command sequences up to the validated landing zone, generated by the sub-module SF07 for calculating trajectory, are next supplied to the sub-module SF05 for formatting commands, the formatted flight command sequences next being transmitted to the autopilot AP.

In the event where the sub-module SF10 for selecting a landing zone cannot determine a valid zone for a safe landing, the drone can carry out an exploration action, comprising the enrichment of the obstacle mapping data.

A safe landing sub-module SF11 may also be activated simultaneously. The safe landing sub-module SF11 triggers, during this loss of altitude, according to data supplied by the data collecting module TC, an evaluation of the landing zone, the precision of this evaluation increasing as the drone loses altitude. The safe landing sub-module SF11 may also include an emergency stop function causing, for example, the stoppage of the drone in still flight. The safe landing sub-module SF11 may notably invalidate the landing zone in order to trigger the search for a new landing zone.

Follow a Surface Module

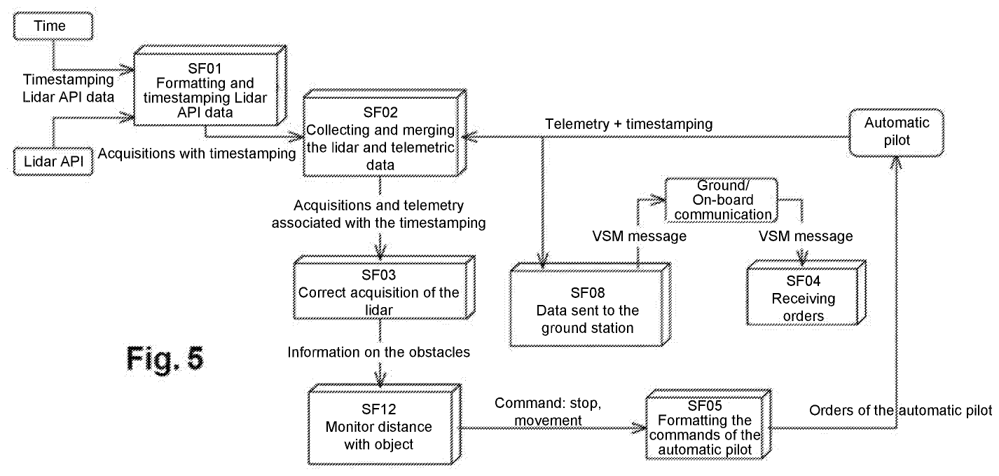

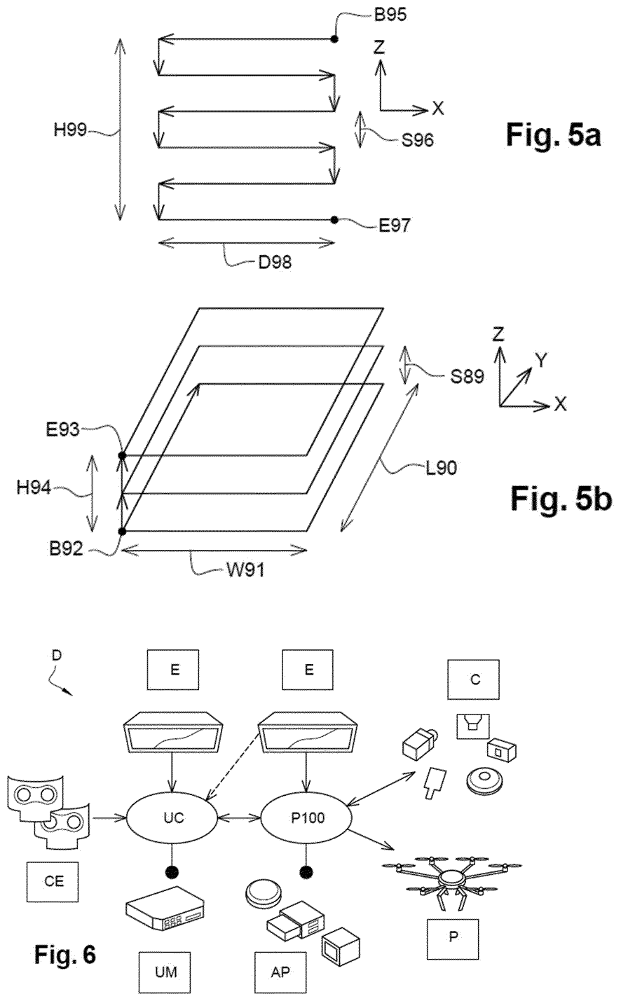

An example of embodiment of the follow a surface module FS is illustrated in FIG. 5. Its purpose is for example to carry out, thanks to an environment sensor CE such as a LIDAR arranged with its field of view frontally or laterally with respect to the drone, a monitoring at a height and at a distance from a substantially vertical zone to cover. The zone thereby covered is for example simultaneously analysed by another analysis sensor or by a camera of the flying platform. The analysed data thereby gathered are for example associated with the detected environment data or with the positioning data generated by the flying platform. A bridge pillar could thereby be analysed in a rapid and accurate manner. It is thereby possible to inspect the surface of an object of which the arrangement, notably its outer surface and its orientation, is not known beforehand. It could also be possible to envisage the following of a surface on a moving object.

The follow a surface module FS includes for example the data collecting module TC itself comprising, as described previously:
the sub-module SF01, for memory writing dated data coming from the environment sensor and the flight control system,
the sub-module SF02, for merging with dated positioning data coming for example from the flight control system,
the correction sub-module SF03, for processing data representative of the environment according to the positioning information of the flying platform.

From data representative of a distance between the drone and the inspected surface, supplied by the data collecting module TC, a sub-module SF12 for controlling the distance between the drone D and the surface of interest generates flight commands in order to, on the one hand, maintain this distance constant and, on the other hand, to cover a determined memorised zone. The constant distance with respect to the obstacle is maintained within a tolerance threshold, stored in the memory. Commands for moving closer or moving further away, along the direction the measurements are taken, are generated to keep the drone at the desired distance. Furthermore, the zone to inspect may be covered according to a linear coverage pattern, a two-dimensional coverage pattern as represented in FIG. 5a or a three dimensional coverage pattern as represented in FIG. 5b.

Two dimensional coverage is for example determined by a memorised input point B95, an output point E97, an inspection height H99, an inspection step S96 and an inspection width D98.

Three dimensional coverage is for example determined by a memorised input point B92, an output point E93, an inspection height H94, an inspection width W91, an inspection depth L90 and an inspection step S89.

The sub-module SF12 is thereby adapted to generating fight commands, so as to maintain a substantially constant distance between the drone D and the surface to inspect while covering this surface. The adaptation of the mission is then carried out permanently.

The flight commands thereby determined are supplied to the formatting driver sub-module SF05 which processes them and transmits them in executable form to the autopilot module AP.

The follow a surface module FS calls for example the sub-module SF08 for formatting data intended for the ground station. This module SF08 transfers for example:
analysis data of the surface generated by an analysis sensor,
positioning data generated by the GPS or the IMU,
data supplied by a camera of the flying platform (P100),
data supplied by the data collecting module TC generated by the environment sensor(s).

Advantageously, the surface inspection module FS facilitates the implementation of a surface examination. The surface examination is all the more efficient when it is based on enhanced adaptability of the drone to its environment.

Again advantageously, certain advanced modules call on the same sub-modules, which facilitates the implementation of the command unit and facilitates the execution of several modules in parallel.

FIG. 6 shows an example of drone D according to the invention comprising different material components.

The on-board command unit UC includes an environment sensor CE and a data processing and memorisation unit UM. The on-board command unit UC also includes an energy supply module E.

The drone D according to the invention includes a flying platform P100 comprising an autopilot and commanded by the command unit. The flying platform P100 includes a flight control system SV, in communication with the command unit, and a support structure P as well as one or more propulsion units. Each propulsion unit includes for example a motor for driving a propeller.

The flying platform P may be a rotary wing or fixed wing flying platform. The flying platform also includes an energy supply module.

In addition to the autopilot module AP, the flying platform P100 includes flight instruments C such as a GPS, an IMU (Inertial Mass Unit) or a camera.

The flying platform P100 is thereby capable of executing the flight commands that are given to it.

The flight control system SV may also include a radiofrequency communication module for communicating with a ground station, notably to make it possible, for safety reasons, to take back commands from the ground station, as explained previously.

Environment sensor(s) include for example:
telemeter or “rangefinder” type measuring one or more distances between the drone D and an object present in the environment of the drone D, or even several telemeters covering several of the zones around the drone,
an optical sensor having characteristics specific to a mission, or even several of these sensors covering several zones around the drone,
a thermal or infrared detector, or even several of these detectors covering several zones around the drone.

The flying platform P100 may also include a system for transporting a load enabling the simple delivery of an object or the deployment in situ of a payload such as a measuring instrument in communication link with the ground station.

A drone D including a system for transporting a load makes it possible for example to carry out missions of delivering a first aid kit to an accident site.

Once again, this type of complex mission may be implemented thanks to the present invention on the basis of reasonable technical, human and financial means.

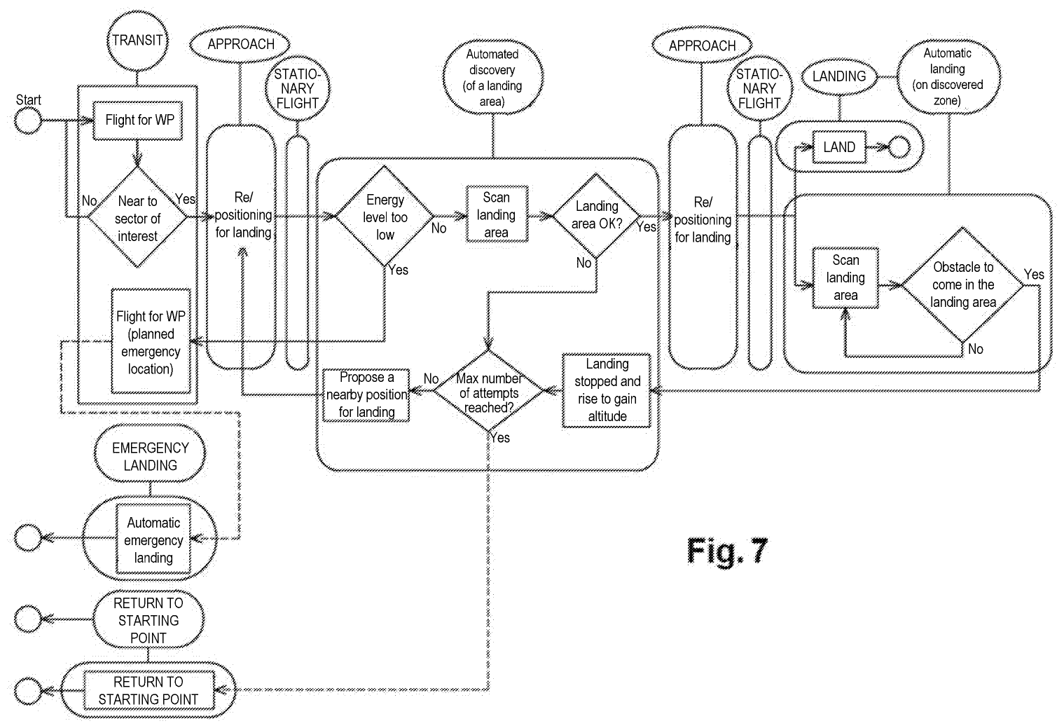

FIG. 7 illustrates an example of sequencing the flight of the drone D in the case of a landing function. As shown in FIG. 7, the flight sequencing carried out by the command unit UM confers considerable autonomy to the drone.

More particularly, FIG. 7 illustrates the relationships between the functions implemented by the command unit UC and the flight phases of the flying platform P100. The flight phases include:
“Transit”: displacement of the drone D along a predetermined trajectory;
“Approach”: the drone approaches its destination;
“Still Flight”: still flight while waiting for instructions to be given to the autopilot module AP.

On approaching the landing zone, the command unit UC may for example carry out an analysis of the landing zone to determine a point suitable for the landing of the drone D according to the invention. The analysis may for example be a scanning of the ground carried out by means of the environment sensor.

If the command unit UC identifies a point which satisfies the criteria for a safe landing, the command unit UC gives instructions to the autopilot module AP to engage a landing procedure, also designated “Landing”.

During this landing phase, the command unit UC may further activate the obstacle avoidance module so as to detect unexpected obstacles that could be encountered in front in the landing zone. In the event of detection of such an obstacle, the command unit UC can then take the decision to interrupt the landing procedure and to return to the base station or to search for another landing zone.

If for example during a phase of searching for a landing zone, no suitable point is detected, the command unit can trigger a search by scanning the ground. The command unit may also trigger a return to the base station or to its take-off point, after a determined number of unsuccessful attempts of searching for landing zones. A standby mode for instructions from the base station may also be triggered by sending a determined request to the base station.

The command unit UC may also trigger an emergency landing in degraded mode, for example if the level of the battery Batt of the drone is too low. In this degraded mode, the landing zone may be selected, for example, according to the inclination and flatness, but according to greater tolerance thresholds or according to the lesser-evil criterion.

The drone system S comprising the drone D and the ground station is also adapted to numerous missions on account of the considerable autonomy of the drone. The mission may for example be continued despite a temporary interruption of the datalink with the ground station. The drone is notably able to trigger actions to re-establish this datalink. The mission may also include partially known exploration zones with feedback of information to the ground station.

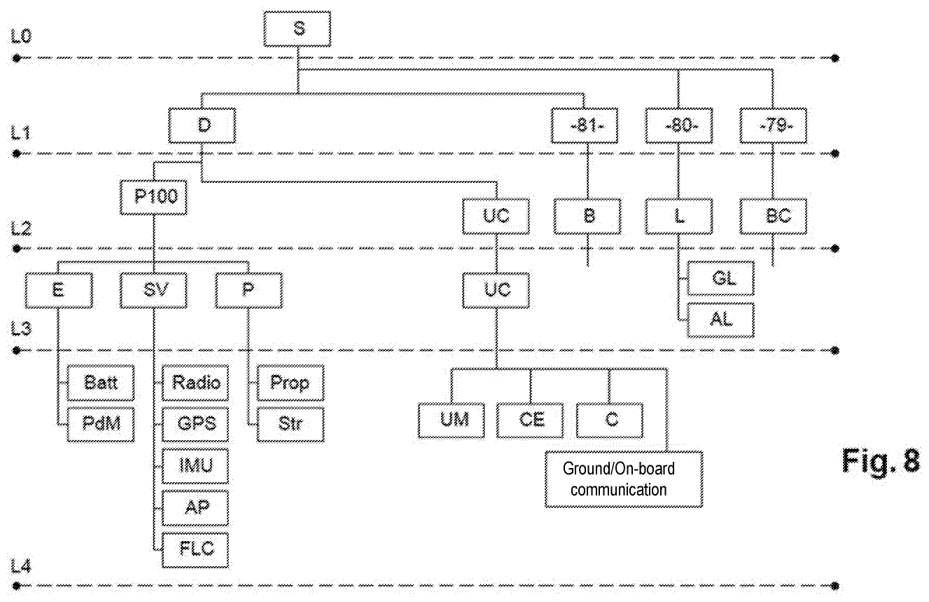

FIG. 8 illustrates an example of drone system S according to the invention comprising:
Elements intended for the ground 81;
The drone D according to the invention;
Data transmission means 80;
Energy supply tools 79.

The elements 81 intended for the ground essentially include a ground station B.

The ground station B may include supply means, data processing and memorisation means, means of communication with the drone.

The base station B makes it possible to recover information sent by the drone D according to the invention, including potential requests for instructions if the command unit UC cannot take a decision. An operator on the ground may for example use the base station B for sending parameterisations to the drone D.

The drone D according to the invention includes the command unit UC and the flying platform P100.

The flying platform includes:
An energy supply module E comprising a battery Batt and a power distribution module PdM;
A flight control system SV comprising a radiofrequency communication module, a GPS module, an inertial measurement unit IMU, an autopilot module AP, a camera FLC;
A flying platform P comprising a mechanical support structure Str and propulsion means Prop.

The command unit UC includes:
The unit UM for processing and memorising mission data and data coming from the environment sensor CE;
One or more environment sensors CE, depending on the mission;
A load transport module C;
A “ground/on-board communication” radiofrequency communication module, as also represented in FIGS. 3 to 5.

The FLC camera may be included in the on-board command unit UC or in the flight control unit SV.

The command unit UC thus includes modules that allow it both to interface with the flying platform P100 and to interpret data acquired notably by its environment sensor(s) CE.

The drone system S according to the invention makes it possible for example to carry out complex missions to completion, in an autonomous manner, without requiring any intervention by the operator on the ground.

The data communication means 80 include a communication link L established between a communication interface on the ground GL and an in-flight communication interface AL. In the present description, this in-fight communication interface is included in the on-board command unit, unless stated otherwise.

The energy supply tools 79 notably include the batteries of the ground station B. The on-board command unit is for example supplied with energy by the battery of the flying platform.

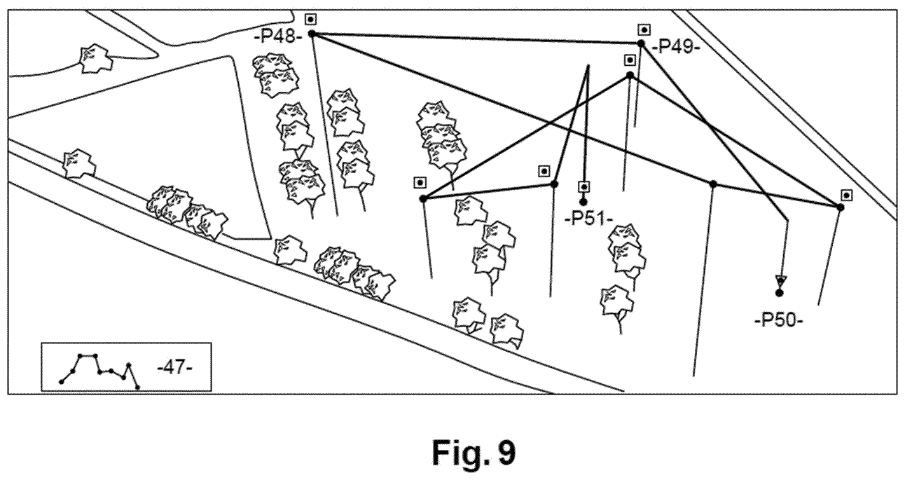

FIG. 9 represents an example of flight plan memorised for a determined mission. This flight plan is for example initially memorised by the on-board command unit. The flight plan includes for example a take-off point P50, a landing point P51 and different way points such as P49 and P48. Each point includes its latitude, its longitude and its altitude. The height is calculated with respect to a mapping frame of reference. The profile of the flight 47 at different heights is also memorised. The map is for example presented in the background on the ground station, while the flight plan is displayed.

### Examples of Cases of Using the Invention

### Rescue Type Missions

During rescue type missions, the real environment is generally modified and potential mapping of the region used for a rescue plan is therefore obsolete. The drone according to the invention has available functions which enable it to adapt to the situation by taking into account for example environmental parameters for the execution of its rescue mission.

The drone S may further be parameterised during flight, in a simple manner, for example by making a zone of interest known to it. The operator identifies for example a zone viewed as being of interest for the search for potential victims and transmits the coordinates of this zone of interest to the drone. The operator communicates with the drone from the ground station in communication link with the drone. This simple parameter allows the drone to adapt its mission in real time. The adaptation is in fact based to a large extent on the environment sensors.

During flight, the drone D according to the invention in fact detects its environment, by means of an environment sensor, for example a laser telemeter or an infrared detector, or by means of a sensor dedicated to the detection of mobile terminals communicating by radio such as for example WiFi, Bluetooth, GSM, LTE. The detected environment may be under the drone, above the drone, in front of, behind or at its sides. The detections carried out by the drone are for example memorised and formatted while being associated with a corresponding geographic position before being transmitted to the ground station. The operator will have for example the possibility of establishing communication with the detected cell phones in order to ask for information directly from the victim. The response given by the victim may be formatted by the victim himself or automatically by physiological parameter measurement devices.

The drone returns for example to its starting point once the zone of interest has been entirely covered.

The drone system according to the invention could easily be programmed for victim rescue missions after, for example, a flood or an earthquake. The functions executed by the drone will be for example:
The detection of victims and the pinpointing of their position with, for example, the establishment of a communication link by mobile telephone with the victims.
The sending of a message, for example of SMS type, to detect the responses of smartphones and to detect the positions of the victims with notably an acknowledgment of receipt message or a return message comprising data on the health condition of individuals.
The exploitation of pinpointing data to display a map for visualising the positions of the victims, this map being able to be used later by rescue teams on the ground, notably by indicating priority victims or the different probabilities of finding survivors according to the detected environment,
Detecting obstacles and their nature, such as for example landslides, fire zones or flooded zones.

### Load Deployment Type Missions

Another example of use relates for example to the deployment of a load. It involves for example laying a sensor type device on the ground or simply delivering a parcel.

It here appears that the drone S according to the invention can take into account its real environment to accomplish its mission without requiring high precision pinpointing beforehand. It is the drone itself that acquires data in the field of operations in order to land, for example, on a balcony or on the roof of a building or instead on grassy ground.

The drone S according to the invention enables an efficient deployment in a simplified manner by landing in an unknown or approximately known zone. Indeed, the efficient deployment of a load requires accurate pinpointing of the environment and the landing zone.

The drone D, when it arrives close to a zone of interest, is going for example to detect and find a landing zone with a sufficient level of safety.

After landing, the drone D activates for example the transported load.

A flight of the drone up to its take-off point or up to another point provided for its landing may then be provided.

### Detection of Toxic Gas

Another example relates to the detection by the drone D according to the invention of toxic gases forming for example a cloud. Indeed, some factories need to be able to detect toxic clouds that can form from their sites.

The drone system according to the present invention enables this type of mission to be carried out simply and at lower cost. This type of toxic cloud detection may be carried out in a preventive manner or in the event of an accident on the site.

The drone D includes for example in its memory a zone of interest where a toxic cloud is capable of being present. These data representative of a geographic exploration zone may be programmed at the same time as the mission or updated in real time by the ground station, via a communication link AL established with the drone. The operator can confirm the execution of the mission after acknowledgment of receipt of an update of the geographic exploration data.

The drone uses for example one or more detectors CE during its flight to evaluate its environment. The environment sensor(s) CE used are for example optical sensors exploited to detect opaque smoke or a colour specific to a toxic cloud or instead probes for detecting chemical components and notably toxic gases. Such a probe will for example be maintained at a distance from the drone to limit aerodynamic perturbations generated by the drone. During the detection of the searched for elements, data representative of the environment are for example stored in a memory, in correspondence with positioning data. The positioning data of the drone include for example the latitude, the longitude and the altitude as well as the inclinations of the drone. Memorisation of environment data thus only takes place for zones of interest. The command unit can also slow down its speed, or even make short pauses, for a more precise examination of its environment, before returning to a faster speed outside of noteworthy zones.

Once the zone of interest has been covered by the drone, said zone returns for example to its take-off point or to another predefined landing point.

The detection of a cloud of smoke or a heat source may also constitute the detection of an obstacle taken into account by the drone, which then carries out an avoidance manoeuvre.

1. An on-board command unit for a flying platform including a flight control system controlling at least one propulsion unit of the flying platform, the flight control system including an autopilot module for managing flight commands, said on-board command unit comprising:
a data processing and memorisation unit, the on-board command unit being configured to be connected to the flight control system and to generate sequences of flight commands addressed to the autopilot module;
wherein the on-board command unit is configured for the management of at least one environment sensor generating data representative of an environment of the flying platform;
wherein the on-board command unit is configured to memorize data for executing a determined mission and carries out a processing of data representative of the environment in such a way as to adapt data for executing the mission according to data coming from said environment sensor and to generate at least one new flight command with respect to the flight commands corresponding to data for executing said initially programmed determined mission.

2. The on-board command unit according to claim 1, wherein said environment sensor (CE) forms part of the command unit and is distinct from other instruments integrated in the flying platform.

3. The on-board command unit according to claim 1, wherein the data processing and memorisation unit includes a data collecting module arranged in such a way as to carry out memory writing of dated data representative of the environment, merging with dated positioning data of the flying platform and correcting of dated data representative of the environment according to the positioning data.

4. The on-board command unit according to claim 1, further comprising a module for formatting commands for the autopilot module and for retransmitting these commands to the autopilot, the module for formatting commands being able to be updated according to the flying platform and its flight control module.

5. The on-board command unit according to claim 1, further comprising a communication module for communicating with a ground station carrying out a transmission of surveillance data generated by the command unit.

6. The on-board command unit according to claim 1, further comprising an obstacle detection and avoidance module, said environment sensor being in the form of at least one detector of distance with respect to objects in the environment of the platform and oriented in the direction of a programmed displacement, the obstacle detection and avoidance module triggering, in the event of a detected distance below a determined threshold, one or more of the following actions:
Stoppage in position,
Avoidance of the obstacle,
Return to a safe position,
Search for a first new trajectory by linear or rotational displacement.

7. The on-board command unit according to claim 6, further comprising a mapping module memorising data representative of obstacles merged with at least positioning data of the flying platform, the data being representative of a mapping of detected obstacles.

8. The on-board command unit according to claim 7, wherein the on-board command unit is configured in such a way that the search for a new trajectory is carried out according to data representative of the mapping of detected obstacles.

9. The on-board command unit according to claim 6, further comprising a landing module carrying out a detection of obstacles vertically below the flying platform to determine a set of points constituting a landing place having an area above a determined threshold and a flatness below a determined threshold.

10. The on-board command unit according to claim 9, wherein the on-board command unit is configured to determine said set of points constituting the landing place by successive iterations during the preparation for the descent of the flying platform.

11. The on-board command unit according to claim 1, further comprising at least one environment sensor, which is a thermal detector, infrared radiation detector or wireless communication terminals detector, the command unit triggering, in the event of a parameter detected above a determined threshold, one or more of the following actions:
stopping for an in-depth analysis of the environment for a determined duration,
slowing down of the speed for an in-depth analysis of the environment for a determined duration or until said detected parameter returns below the detection threshold,
search for a second new trajectory for amplifying the detected parameter,
the detected parameter being able to be in the form of a thermal signature of determined intensity, a thermal image of determined extent, a digital radiofrequency signal of determined intensity.

12. A drone including at least one flying platform equipped with a flight control system controlling at least one propulsion unit of the flying platform, the flight control system including an autopilot module for managing flight commands, the drone comprising an on-board command unit according to claim 1.

13. The drone according to claim 12, further comprising a device for transporting a load intended to be set down in a determined place.

14. A drone system including a ground station in communication link with a drone according to claim 12.
